(19) United States
(12) Patent Application Publication
(10) Pub. No.: US 2023/0214284 A1
(43) Pub. Date: Jul. 6, 2023

(54) SCHEDULING FUNCTION CALLS OF A TRANSACTIONAL APPLICATION PROGRAMMING INTERFACE (API) PROTOCOL BASED ON ARGUMENT DEPENDENCIES

(71) Applicant: Intel Corporation, Santa Clara, CA (US)

(72) Inventors: Joseph Grecco, Saddle Brook, NJ (US); Mukesh Gangadhar Bhavani Venkatesan, Bangalore (IN); Hariharan M, Palakkad (IN)

(73) Assignee: Intel Corporation, Santa Clara, CA (US)

(21) Appl. No.: 17/973,328

(22) Filed: Oct. 25, 2022

(51) Int. Cl. G06F 9/54

(52) U.S. Cl. CPC G06F 9/547

(57) ABSTRACT

Embodiments described herein are generally directed to improving performance of a transactional API protocol by scheduling function calls based on data dependencies. In an example, a function associated with the transactional API is received that is to be carried out by an executer on behalf of an application. It is determined whether the function has a dependency on a value that is invalid. If so, execution of the function is delayed by causing a function ID of the function to be queued for a global memory reference associated with the value. After the value becomes valid, the function is caused to be executed by the executer. When the first function is determined to have no such dependency, the function may be immediately scheduled for execution by the executer without delay.

### TECHNICAL FIELD

Embodiments described herein generally relate to the field of remote procedure call (RPC) technology and, more particularly, to improving performance of a transactional application programming interface (API) protocol by scheduling function calls based on data dependencies (e.g., argument dependencies), for example, to change the order and/or concurrency of function execution.

### BACKGROUND

RPC is a software communication protocol that one program (e.g., an application) running on a client (e.g., an application platform) can use to request a service from a remote compute resource (e.g., a central processing unit (CPU), a graphics processing unit (GPU), application-specific integrated circuit (ASIC), or a field-programmable gate array (FPGA)), which may be referred to herein as an executer.

A transactional API protocol generally represents an interface scheme that makes use of RPCs (which may be referred to herein as function calls) in which performance of an atomic unit of work involves invoking a prescribed sequence of function calls. A transactional API may be implemented in the form of various types of RPC platforms or frameworks, including representational state transfer (REST), gRPC, and graph query language (GraphQL).

### BRIEF DESCRIPTION OF THE DRAWINGS

Embodiments described here are illustrated by way of example, and not by way of limitation, in the figures of the accompanying drawings in which like reference numerals refer to similar elements.

FIG. 1A is a block diagram illustrating actors involved in a transactional API protocol.

FIG. 1B is a message sequence diagram illustrating delays incurred in connection with an exchange of messages of a transactional API protocol between an application and an executer.

FIG. 2 is a block diagram illustrating an operational environment supporting scheduling of function calls of a transactional API protocol based on argument dependencies according to some embodiments.

FIG. 3 is a high-level flow diagram illustrating operations for performing function scheduling according to some embodiments.

FIG. 4 is a flow diagram illustrating operations for performing function call pre-processing according to some embodiments.

FIG. 5 is a flow diagram illustrating operations for performing function dispatching according to some embodiments.

FIG. 6 is a flow diagram illustrating operations for performing service scheduling according to some embodiments.

FIG. 7 is a flow diagram illustrating operations for performing memory management according to some embodiments.

FIGS. 8A-G are message sequence diagrams illustrating step-by-step processing of a sequence of function calls according to some embodiments.

FIG. 9 is an example of a computer system with which some embodiments may be utilized.

### DETAILED DESCRIPTION

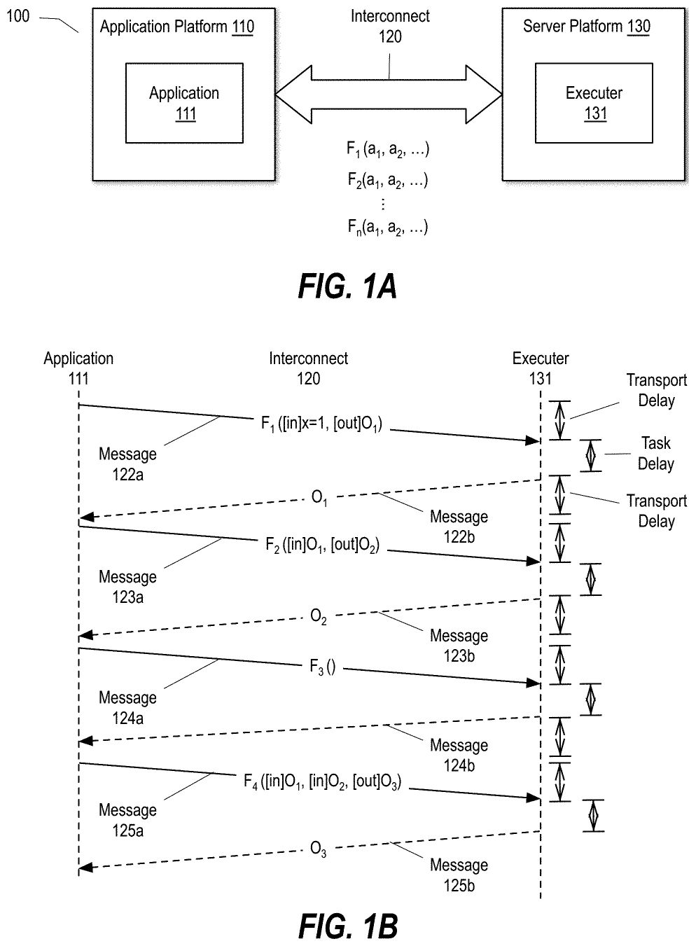

Embodiments described herein are generally directed to improving performance of a transactional API protocol by scheduling function calls based on data dependencies. As illustrated by the example described below with reference to FIGS. 1A-B, invoking multiple function calls of a transactional API protocol over a network or other high-latency interconnect in order to have a unit of work performed remotely, introduces undesirable latency and network resource usage.

FIG. 1A is a block diagram illustrating actors involved in a transactional API protocol. In the context of FIG. 1A, an application platform 110 and a server platform 130 are coupled via an interconnect 120. The application platform 110 may represent a first computer system and the server platform 130 may represent a second (remote) computer system. Alternatively, the application platform 110 may represent a first compute resource (e.g., a CPU) of a computer system and the server platform 130 may represent a second compute resource (e.g., a GPU) on the same computer system. In the case of the former, the interconnect 120 may represent a network. In the case of the latter, the interconnect 120 may represent a peripheral component interconnect express (PCIe) bus. In either case, the interconnect 120 typically represents a performance bottleneck as the transport latency is relatively higher than as compared to communications performed within the application platform 110 or within the server platform 130.

An application 111 running on the application platform originates function calls and an executer 131 within the server platform 130 performs the work associated with the function calls. In the context of the present example, it is assumed an atomic unit of work is performed by the executer 131 responsive to a prescribed set of function calls (i.e., F₁(a₁, a₂, . . . ), F₂(a₁, a₂, . . . ), . . . Fₙ(a₁, a₂, . . . )) of a transactional API protocol originated by the application 111, in which each function call is sent across the interconnect 120 via a separate message.

FIG. 1B is a message sequence diagram illustrating delays incurred in connection with an exchange of messages of a transactional API protocol between an application (e.g., application 111) and an executer (e.g., executer 131). In the context of the present example, an ordered sequence of function calls (F₁, F₂, F₃, and F₄) is originated by the application and sent via the interconnect 120 to the executer. Message 122a represents a request on behalf of the application for the executer to remotely execute a function (F₁). F₁ includes two arguments, an immediate input passed as a literal constant and an output variable argument (O₁). Message 122b represents an indication of completion of F₁ and includes the value of O₁.

After receipt of message 122b and the value of O₁, the application may then send message 123a, representing a request on behalf of the application for the executer to remotely execute a function (F₂). F₂ includes two arguments, an input variable argument (O₁) and an output variable argument (O₂). Message 123b represents an indication of completion of F₂ and includes the value of O₂.

After receipt of message 123b and the value of O₂, the application may then send message 124a, representing a request on behalf of the application for the executer to remotely execute a function (F₃). F₃ has no input or output arguments. Message 124b represents an indication of completion of F₃.

After receipt of message 124b, the application may then send message 125a, representing a request on behalf of the application for the executer to remotely execute a function (F₄). F₄ includes three arguments, two input variable arguments (O₁ and O₂) and an output variable argument (O₃). Message 125b represents an indication of completion of F₄ and includes the value of O₃.

In this example, it can be seen that F₁ has no dependencies and F₂ has a dependency on the output O₁ from the preceding F₁ call. Similarly, F₄ is dependent on F₁ and F₂ for the values of O₁ and O₂, respectively. F₃ has no dependencies. Further assume that O₃ is the only output that the application cares about the value of (i.e., it is the result of an atomic work task). From this example, it can be seen, the transport API protocol incurs a transport delay for every function call. In addition, an interconnect bandwidth penalty is added for each output variable argument returned across the interconnect 120 that is not required by the application. In this case O₁ and O₂ are simply passed back to the executer.

As can be seen from FIG. 1B, a significant source of latency and/or network utilization is the transport of the request/response data. Performance gains could be achieved if an application could schedule sequences of functions without waiting for intermediate responses (e.g., messages 122b, 123b, and 124b). As described further below, such an approach would result in improved execution performance by avoiding the transport delay associated with the intermediate responses (e.g., messages 122b, 123b, and 124b). To address the forward reference issue raised by a yet to be ascertained value (an invalid value) of an output variable argument of one function of a sequence of multiple function calls potentially being used as an input to a subsequent function of the sequence, various embodiments make use of a memory manager that manages allocation and access to argument data storage via respective global memory references.

Various embodiments described herein seek to improve the performance of transactional API protocols by making use of API arguments to infer concurrency rules of a transactional API protocol and using the inferences to schedule function requests in an optimized fashion. For example, according to one embodiment, the use of a centralized or distributed memory manager enables a function scheduler implemented on a server platform to automatically serialize and even reorder function execution, allowing other functions to run concurrently, further improving performance. Embodiments described herein also minimize the data to be returned to the application, reducing load on the interconnect (e.g., network or internal computer system bus). All of this can be done without the function scheduler having detailed knowledge of the transactional API protocol at issue.

As described further below, in one embodiment, information indicative of a function associated with a transactional application programming interface (API) that is to be carried out by an executer on behalf of an application is received, for example, by a function scheduler running on a server platform and fronting a remote compute service (e.g., an executer). A determination is made regarding whether the function has a data dependency on a value that is invalid. This determination may involve the use of a memory manager that controls allocation, mutation, access, and the state of a store holding the actual argument data. This enables forward reference to arguments allowing the function scheduler and/or the memory manager to change the order and concurrency of function execution.

If the above determination is affirmative (indicating the function has a data dependency on a value that is currently invalid), then a function identifier (ID) of the function is caused to be queued on a pending queue (e.g., maintained by the memory manager) for a global memory reference associated with the value at issue. After the value at issue is valid (e.g., after being set as a result of completion of execution of another function), then an indication is received by the function scheduler (e.g., by the memory manager) that the function is ready to be executed.

Otherwise, if the above determination is negative (indicating the function either has no data dependency or has a data dependency on a value that is valid), then the function may be immediately executed (e.g., without waiting for completion of a currently executing function) by causing the function to be executed by the executer.

In one embodiment, an API-aware component operable on the application platform (e.g., the application itself, a function dispatcher on the application platform, a library, supplied by the application platform or the transactional API protocol provider) makes use of its awareness of the transaction API protocol to facilitate tagging of function arguments as input reference, output reference, or immediate (i.e., constant) if the argument types are discernable.

In the following description, numerous specific details are set forth in order to provide a thorough understanding of example embodiments. It will be apparent, however, to one skilled in the art that embodiments described herein may be practiced without some of these specific details.

### Terminology

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, an “application” generally refers to software and/or hardware logic that originates function requests of a transactional API protocol.

As used herein, a “function descriptor” generally refers to a transmissible record describing a single function invocation of a transactional API protocol. A function descriptor may include one or more of a function identifier (ID) (e.g., a unique string representing the name of the function) corresponding to the command, and a global memory reference for each variable argument of the function.

As used herein, the phrase “global memory reference” generally refers to a token that identifies argument data storage. A given global memory reference uniquely identifies the same value on all platforms (e.g., an application platform and a server platform) on which it is used.

As used herein, an “executer” generally refers to software and/or hardware logic that performs the work described by a function descriptor. An executer may represent a compute service or resource remote from the application on behalf of which it performs the work.

As used herein, an “interconnect” generally refers to any physical or logical mechanism for transmitting data suitable for implementing a function descriptor. Non-limiting examples of an interconnect include a network or a PCIe bus.

As used herein, the phrase “transactional API protocol” generally refers to an interface scheme that makes use of RPCs in which performance of an atomic unit of work may involve invoking a prescribed sequence of function calls (e.g., the interactive and sequential receipt of requests and issuance of corresponding responses). This is in contrast to an interface that uses a single function to perform a work task. A transactional API may be implemented in the form of various types of RPC platforms or frameworks, including representational state transfer (REST), gRPC, and graph query language (GraphQL). Non-limiting examples of transactional API protocols include Intel oneAPI, compute unified device architecture (CUDA), and open computing language (OpenCL).

The terms “component”, “platform”, “system,” “scheduler,” “dispatcher,” “manager” and the like as used herein are intended to refer to a computer-related entity, either a software-executing general purpose processor, hardware, firmware, or a combination thereof. For example, a component may be, but is not limited to being, a process running on a compute resource, an object, an executable, a thread of execution, a program, and/or a computer.

### Example Operational Environment

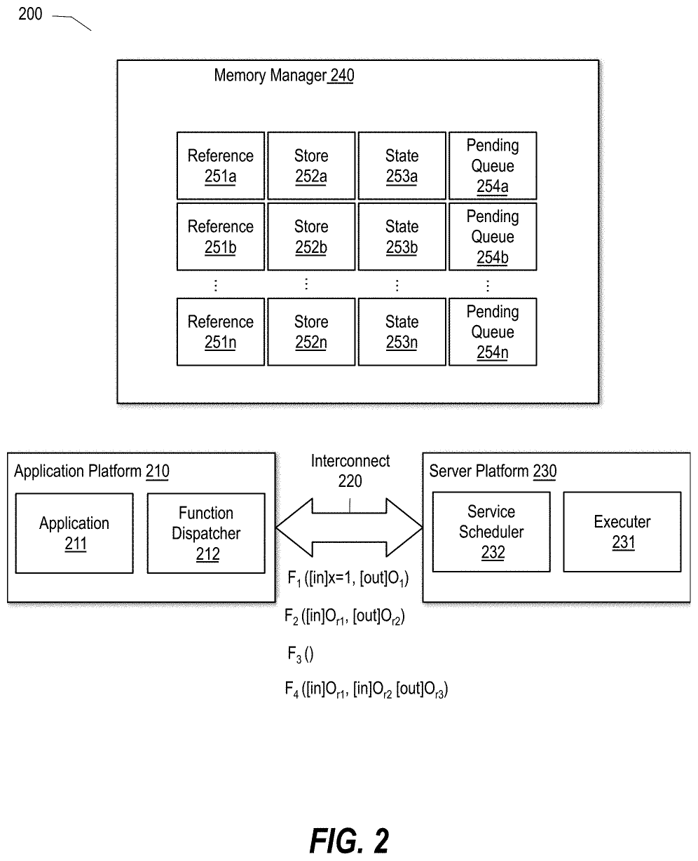

FIG. 2 is a block diagram illustrating an operational environment 200 supporting scheduling of function calls of a transactional API protocol based on argument dependencies according to some embodiments. In the context of the present example, the operational environment 200 is shown including an application platform 210, an interconnect 220, a server platform 230, and a memory manager 240. As above, the application platform 210 may represent a first computer system and the server platform 230 may represent a second (remote) computer system. Alternatively, the application platform 210 may represent a first compute resource (e.g., a CPU) of a computer system and the server platform 230 may represent a second compute resource (e.g., a GPU) on the same computer system. When the application platform 210 and the server platform 230 are separate computer systems, the interconnect 220 may represent a network. When the application platform 210 and the server platform 230 are within the same computer system, the interconnect 220 may represent a PCIe bus or a compute express link (CXL) interconnect. As explained above with reference to FIG. 1A, in either case, the interconnect 220 typically represents a performance bottleneck as the transport latency is relatively higher than as compared to communications performed within the application platform 210 or within the server platform 230.

The application platform 210 is shown including an application 211 and a function dispatcher 212. The application 211 may represent software and/or hardware logic that originates function requests. The function dispatcher 212 is responsible for forwarding function calls made by the application 211 over the interconnect 220 to the server platform 230 (and more specifically to a service scheduler 232 of the server platform 230). The function calls may be sent asynchronously and the order of receipt on the other end of the interconnect 220 is not guaranteed. In one embodiment, the function dispatcher 212 may insulate the application 211 from certain details associated with determining and/or tagging of function arguments (e.g., as an input reference, an output reference, or an immediate). Alternatively, the function dispatcher 212 may be part of the application 210. The function calls (e.g., F₁, F₂, F₃, and F₄) may be transmitted via the interconnect 220 in the form of function descriptors each containing respective function IDs and global memory references (obtained from the memory manager 240) for corresponding input and/or output variable arguments.

The server platform 230 is shown including a service scheduler 232 and an executer 231. The executer 231 may represent software and/or hardware logic that performs the work described by a function descriptor. The service scheduler 232 may be responsible for scheduling the execution of the functions described by the function descriptors received from the function dispatcher 212 by the executer 231. The service scheduler 212 may insulate the executer 231 from details associated with the use of the memory manager 240 and global memory references. Alternatively, the service scheduler 232 may be part of the executer 231.

In the context of the present example, the memory manager is shown including global memory references (e.g., references 251a-n), corresponding stores (e.g., store 252a-n), corresponding states (e.g., state 253a-n) of the stores (e.g., valid or invalid), and corresponding lists (e.g., pending queues 254a-n). The memory manager 240 may represent software and/or hardware logic that manages allocation and access to memory based on a global memory reference. For example, the memory manger 240 may be used to get and set values (e.g., within stores 252a-n) for respective global memory references (e.g., references 251a-n) assigned by the memory manager 240. Each global memory reference may represent a token that uniquely identifies data storage (e.g., one of stores 252a-n) for a given variable argument of a function. The global memory references may serve as place holders for the real values of input and/or output variable arguments of functions that are yet to be computed, thereby allowing an output variable argument of one function of an ordered sequence of function calls made by the application 211 to be forward referenced by an input variable argument of subsequent function of the ordered sequence of function calls. The memory manager 240 may be implemented as a single centralized service (e.g., a microservice) or daemon or as multiple distributed components (e.g., one component residing on the application platform 210 and another component residing on the server platform 230).

### High-Level Example of Function Scheduling

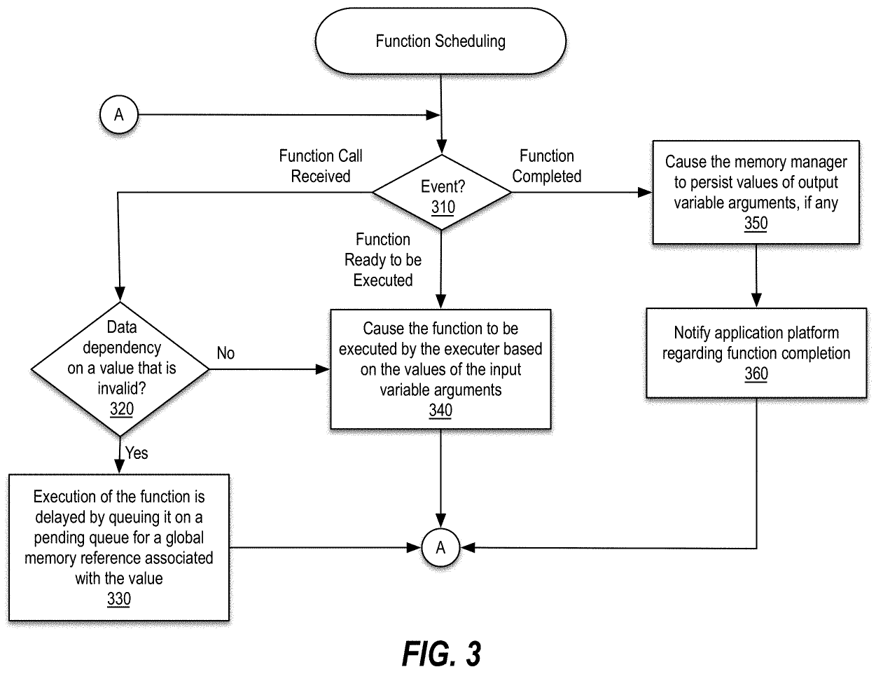

Before going into a more detailed description of end-to-end processing and specific operations that may be performed by the various components described above with reference to FIG. 2 in accordance with various embodiments, a brief overview of function scheduling is provided with reference to FIG. 3. According to various examples described herein the existence or non-existence of data dependencies, for example, between/among sequentially submitted function calls may be identified in real-time and used to allow overlapping execution of one or more of the function calls and/or reordering of the function calls as appropriate. For instance, a function call with no data dependencies (or resolved data dependencies (e.g., dependencies on stores that are valid)) may be immediately executed, whereas a given function call with any unresolved data dependencies (e.g., a dependency on a store that is currently invalid) may be delayed until all of its data dependencies are resolved.

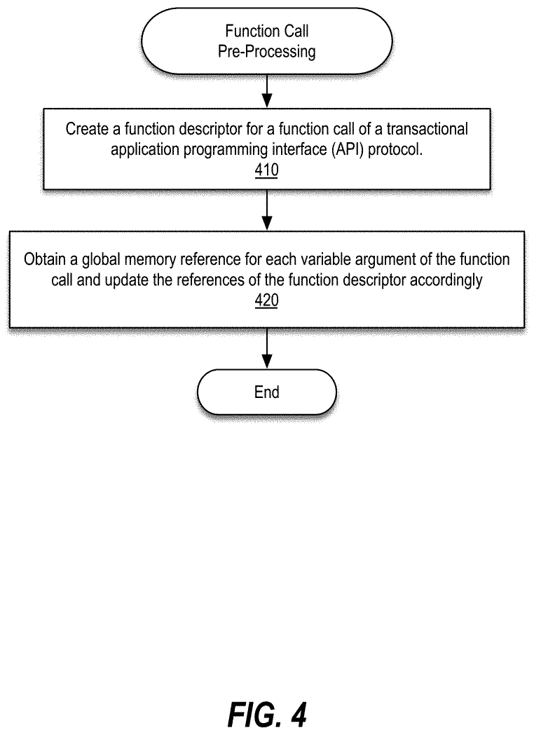

FIG. 3 is a high-level flow diagram illustrating operations for performing function scheduling according to some embodiments. In one embodiment, function scheduling is performed by a service scheduler (e.g., service scheduler 232) after an event is received that is indicative of receipt of a function call transmitted by a function dispatcher (e.g., function dispatcher 212) via an interconnect (e.g., interconnect 220), an event that is indicative of a function (previously delayed is now ready to be executed), or an event that is indicative of completion of execution of a given function call by an executer (e.g., executer 231). As described further below with reference to FIG. 4, in one embodiment, input and output variable arguments of a given function are replaced with corresponding global memory references though which allocation, mutation, access, and the states of stores holding the actual values of the arguments data (values) are controlled by a memory manager (e.g., memory manager 240).

At decision block 310, a determination is made regarding what the event represents. If the event represents receipt of a function call, processing continues with decision block 320. If the event represents a function (previously delayed) is now ready to be executed, processing continues with block 340. If the event represents, completion of execution of a function call, processing branches to block 350.

At decision block 320, a determination is made regarding whether the function call has a data dependency on a value that is invalid. The function call may be transmitted from an application platform (e.g., application platform 210), for example, by a function dispatcher (e.g., function dispatcher 212) in the form of a function descriptor that describes the function request and its arguments. Arguments may be immediate or variable. Immediate arguments are inputs passed as literal constants. Variable arguments are arguments whose value can change after creation (e.g., as a result of a previous function request or in the case of an input buffer, by an application). Variable arguments may be further typed as input or output and are represented via respective global memory references, which may be obtained from the memory manager.

In one embodiment, the data dependency determination is made with reference to the input argument global memory references (that are used in place of the corresponding input variable arguments) of the function call. For example, the service scheduler may use a memory manager (e.g., memory manager 240) to examine the states (e.g., some subset of states 253a-n) of all input argument references (e.g., some subset of references 251a-n) of the function request. If any do not have a valid value in their respective stores (e.g., some subset of stores 252a-n) as indicated by their corresponding states, processing continues with block 330; otherwise, processing branches to block 340.

At block 330, the function is placed on a list (e.g., one of pending queues 254a-n) for each input argument global memory reference that is invalid (the value has not been set). For example, the memory manager may add the function ID of the function call to those of the lists associated with any input argument global memory references for which the state of the store is invalid. After block 330, processing loops back to decision block 310 to handle the next event.

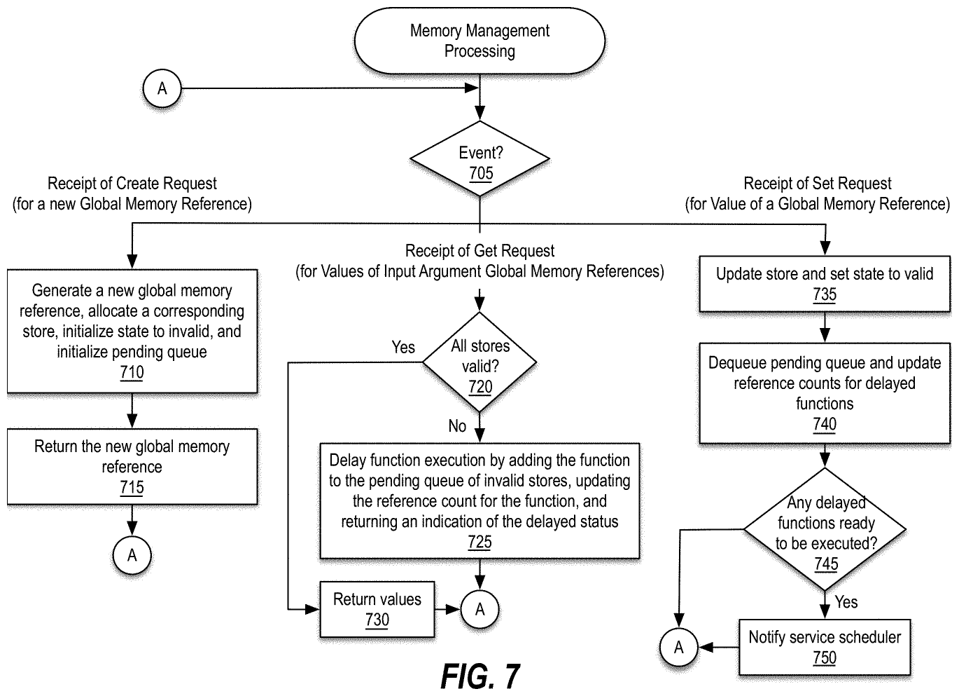

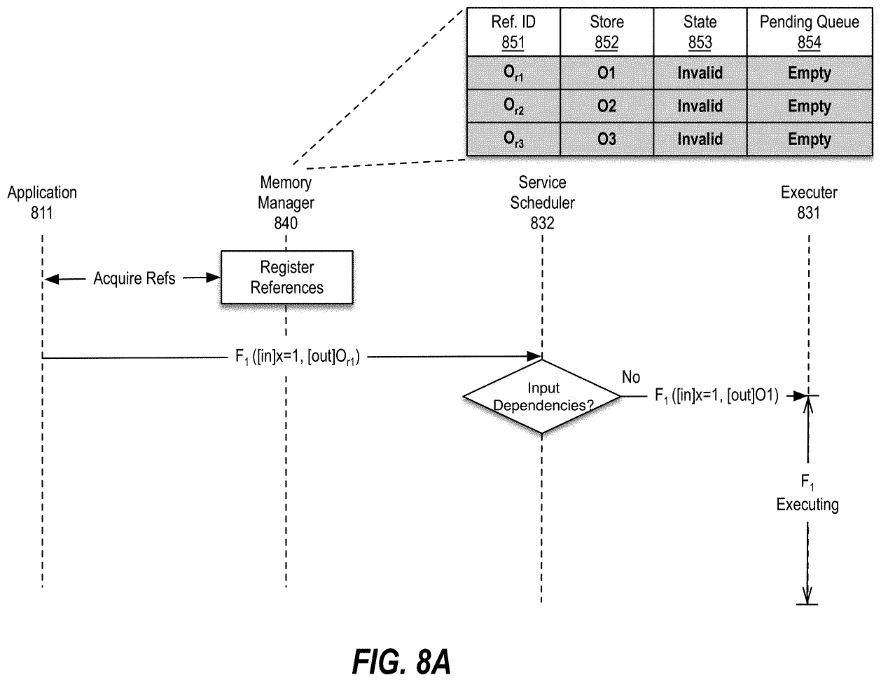

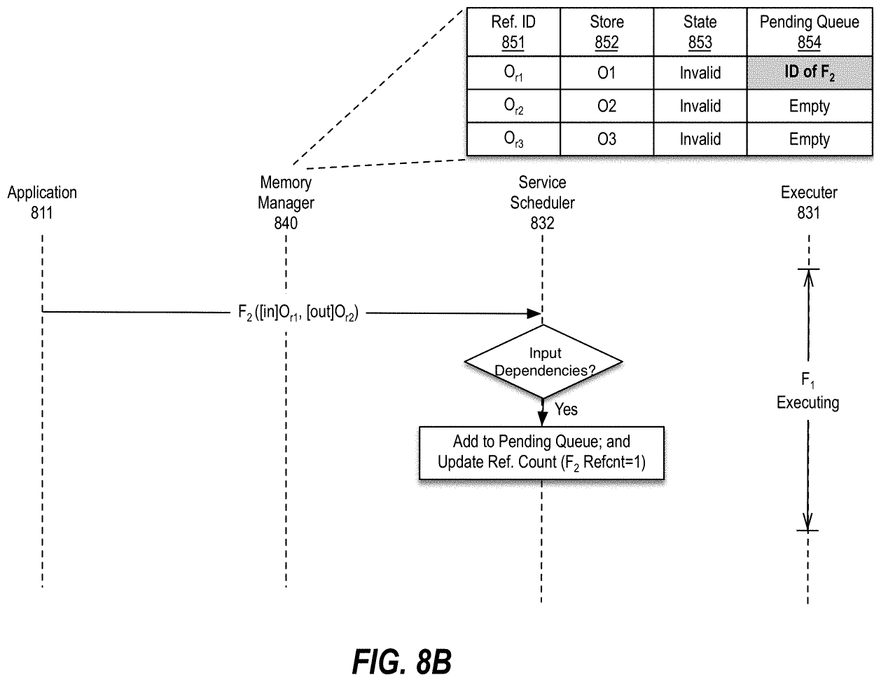

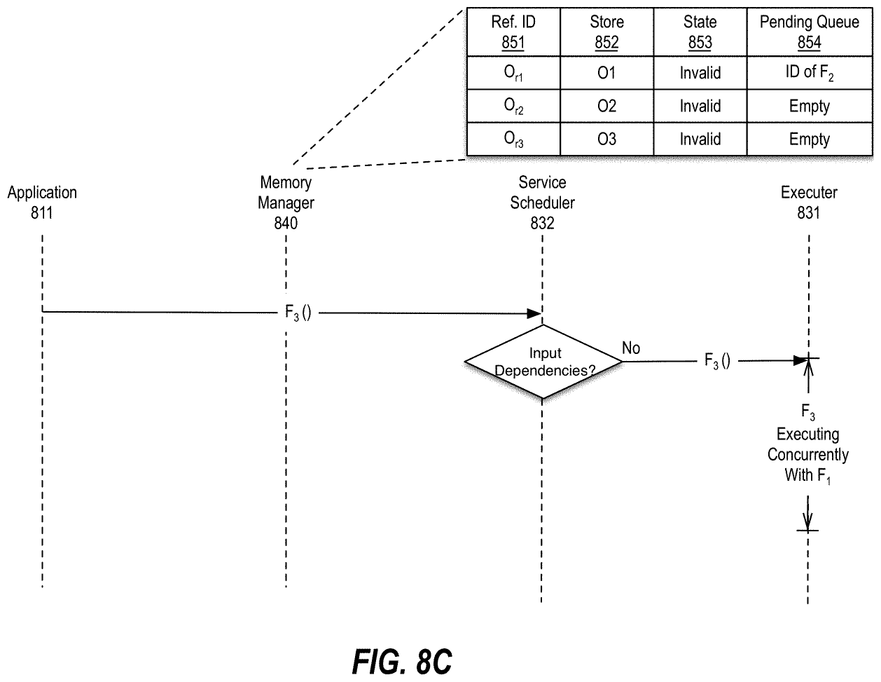

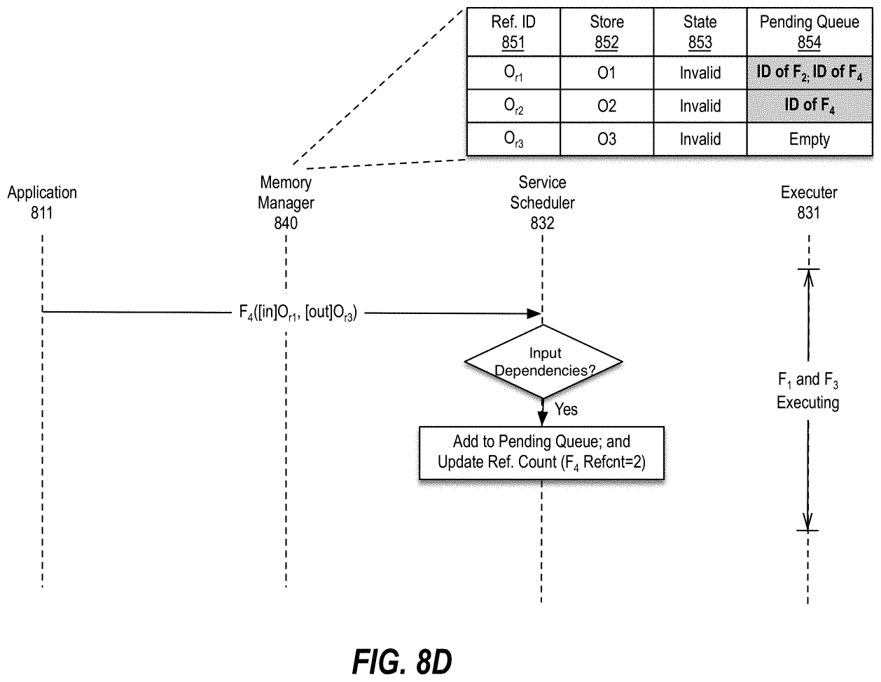

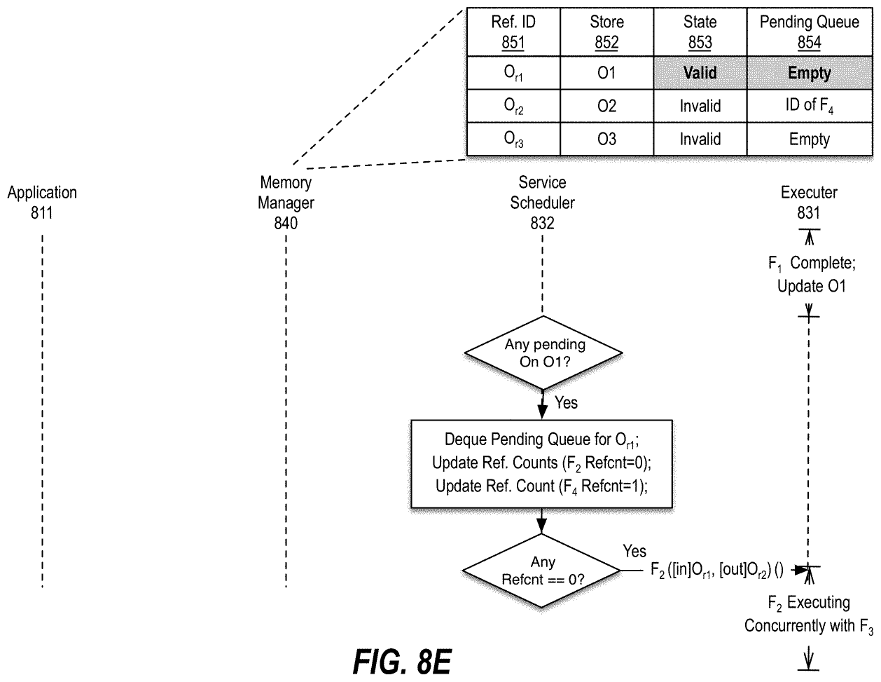

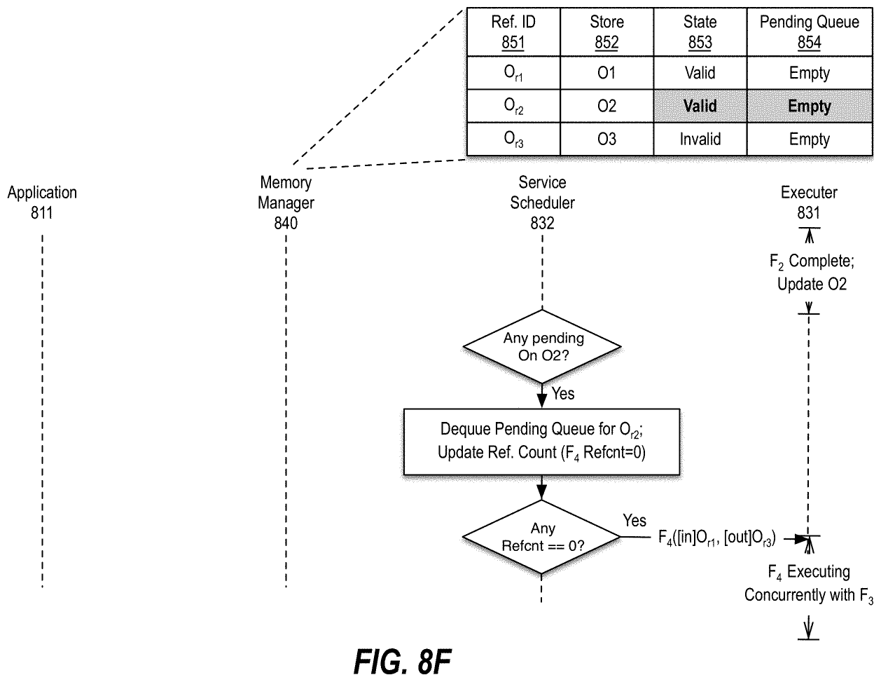

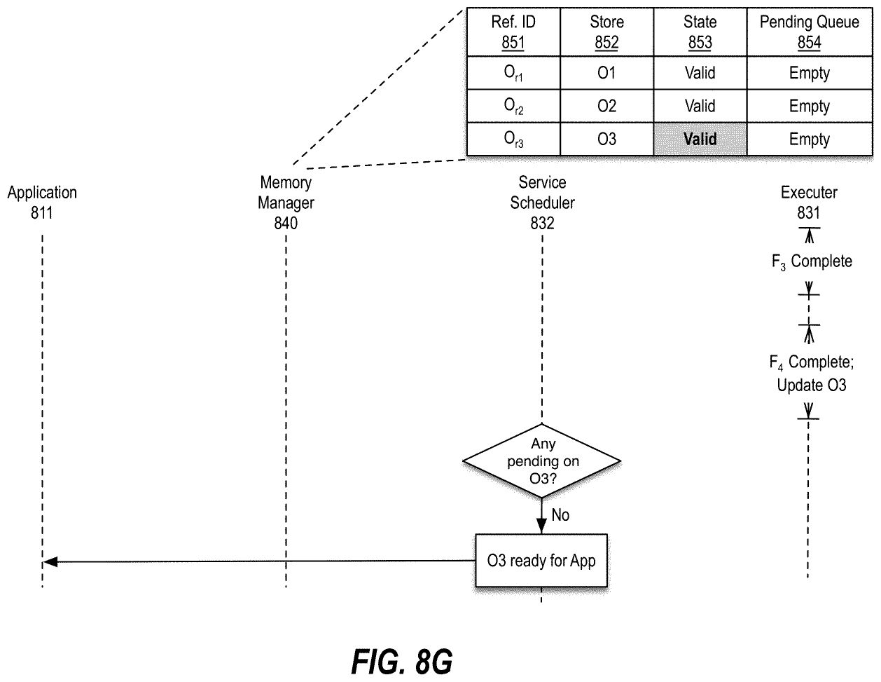

At block 340, either the “No” branch of decision block 320 has been taken or the “Function Ready to be Executed” branch of decision block 310 has been taken. According to one embodiment and as described further below with reference to FIGS. 7 and 8A-G, the memory manager may track when a given function previously delayed (queued) for later execution in block 330 is ready for execution. For example, after all values on which the given function is dependent are valid, the memory manager inform the service scheduler. In any event, regardless of the path taken to arrive at block 340, the function is now caused to be executed by the executer. For example, the service scheduler may enable locally accessible storage be made available for the input variable arguments and may cause the executer to carry out the function based on the values of the input variable arguments of the function retrieved from or provided by the memory manager. After block 340, processing loops back to decision block 310 to handle the next event.

At block 350, the memory manager is caused to persist values of output variable arguments of the completed function. For example, responsive to the service scheduler being informed of completion of execution of the function and being provided with the values of any output variable arguments of the function by the executer, the service scheduler may request the memory manager to persist the values to stores associated with corresponding output argument global memory references (that are used in place of the corresponding output variable arguments) of the function call.

At block 360, the application platform is notified regarding function completion. For example, the service scheduler may transmit information indicative of the function call (e.g., the function ID) and the output argument global memory references to the function dispatcher via the interconnect. After block 360, processing loops back to decision block 310 to handle the next event.

With the foregoing overview in mind, a more detailed description of end-to-end processing and specific operations that may be performed by the various components described above with reference to FIG. 2 in accordance with various embodiments, will now be provided with reference to FIGS. 4-7.

### Example Function Call Pre-Processing

FIG. 4 is a flow diagram illustrating operations for performing function call pre-processing according to some embodiments. In one embodiment, function call pre-processing includes creation of a function descriptor for a given function call of a transactional API protocol prior to invocation of the given function call or as part of the invocation of the given function call by an application (e.g., application 211). The processing described with reference to FIG. 4 may be performed by an API-aware component. The API-aware component may be part of the application itself or may be a library or companion optimization plug-in supplied by an application platform (e.g., application platform 210) on which the application runs or supplied by the provider of the transactional API protocol. Alternatively, a function dispatcher (e.g., function dispatcher 212) logically interposed between the application and a server platform (e.g., server platform 230) may represent the API-aware component.

At block 410, a function descriptor is created for the given function call. In one embodiment, the function descriptor represents a transmissible record describing invocation of the given function call and includes a function ID and references for each input and output variable argument of the given function call. The function ID may be a unique string representing the name of the function or command to be carried out by the executer (e.g., executer 231).

At block 420, a global memory reference is obtained for each variable argument associated with the given function call and the references of the function descriptor are set to corresponding global memory references. For example, the API-aware component may loop through all arguments of the given function call and when the argument represents a variable arguments, the API-aware component may request a new global memory reference for the variable argument and include the new global memory reference within the function descriptor. According to one embodiment, and as described further below in connection with FIG. 7, global memory references may be obtained from a memory manager (e.g., memory manager 240).

### Example Function Dispatching Processing

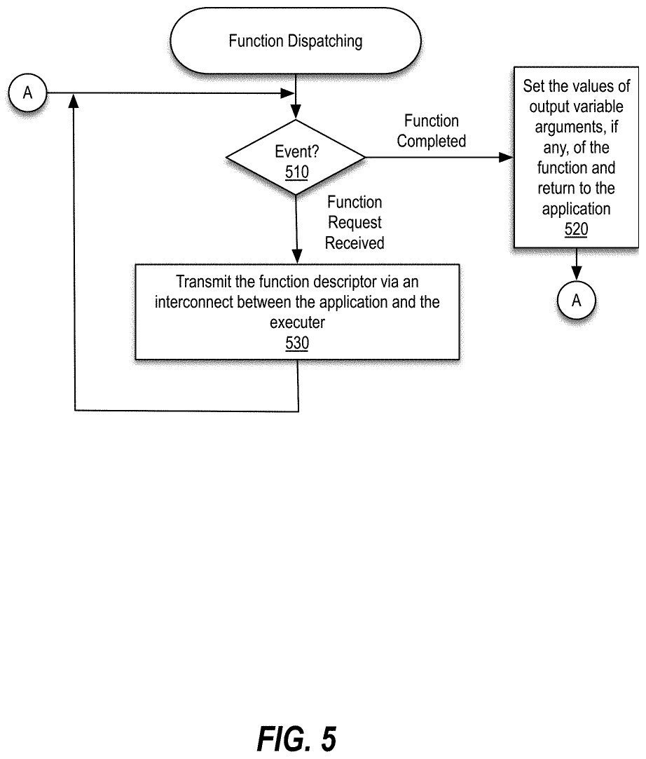

FIG. 5 is a flow diagram illustrating operations for performing function dispatching according to some embodiments. In one embodiment, function dispatching processing is performed by a function dispatcher (e.g., function dispatcher 212) after receipt of an event that is indicative receipt of a function request, for example, in the form of a function descriptor, or after receipt of an event that is indicative of completion of execution of function. Function requests may be received directly from an application (e.g., application 211) or via an API-aware component (e.g., a library or companion optimization plug-in associated with the transactional API protocol) logically interposed between the application and the function dispatcher. A notification of completion of execution of a function may be sent from a service scheduler (e.g., service scheduler 232) to the function dispatcher.

At decision block 510, a determination is made regarding what the event represents. If the event represents receipt of a function request, processing continues with block 530; otherwise, when the event represents completion of execution of a previously dispatched function, processing branches to block 520.

At block 520, the values of output variable arguments of the function are retrieved and returned to the application. For example, the function dispatcher may obtain the values of the output variable arguments of the function from a memory manager (e.g., memory manager 240) based on the corresponding global memory references. Following block 520, function dispatching processing may loop back to decision block 510 to process the next event.

At block 530, the function descriptor is transmitted via an interconnect (e.g., interconnect 220) between an application platform (e.g., application platform 210) on which the application is running and a server platform (e.g., server platform 230) including an executer (e.g., executer 231) that is to remotely carry out the function. Following block 530, function dispatching processing may loop back to decision block 510 to process the next event.

### Example Service Scheduling Processing

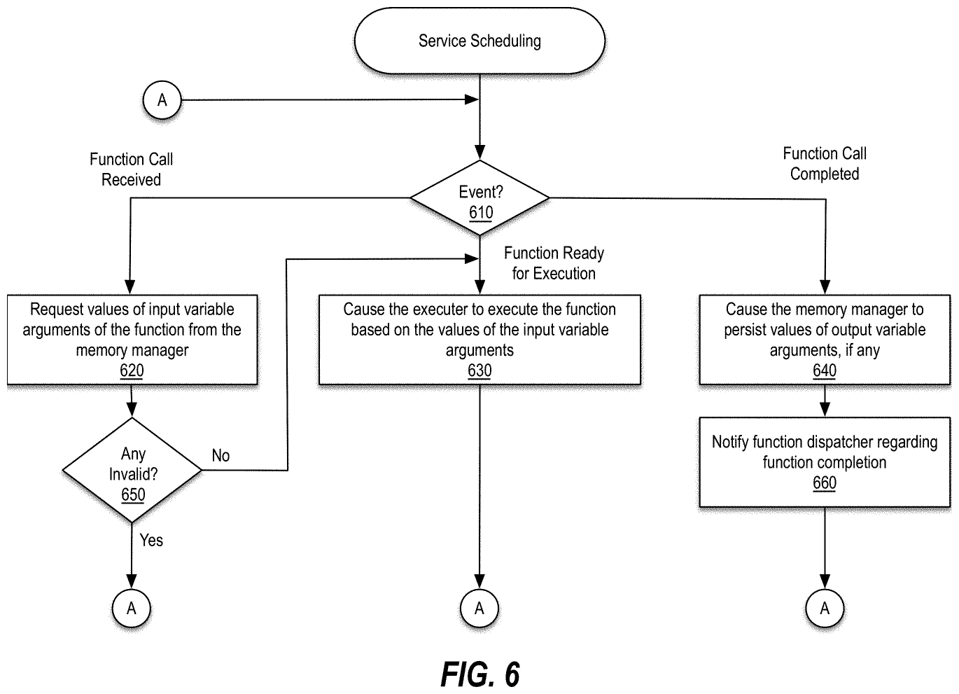

FIG. 6 is a flow diagram illustrating operations for performing service scheduling processing according to some embodiments. In one embodiment, service scheduling is performed by a service scheduler (e.g., service scheduler 232) after an event is received that is indicative of receipt of a function call transmitted by a function dispatcher (e.g., function dispatcher 212) via an interconnect (e.g., interconnect 220) or an event that is indicative of completion of execution of a given function call by an executer (e.g., executer 231).

At decision block 610, a determination is made regarding what the event represents. If the event represents receipt of a function call, processing continues with block 620. If the event represents an indication that a function (previously delayed) is now ready for execution, processing branches to block 630. If the event represents an indication that a function call has been completed, processing continues with block 640.

At block 620, the values of input variable arguments of the function call are retrieved. For example, the service scheduler may invoke a method (e.g., a get method) exposed by the memory manager to acquire the values associated with corresponding global memory references. As described further below with reference to FIGS. 7 and 8A-G, when the state of a store of any of the global memory references are invalid, execution of the function is delayed until all values (e.g., values of input variable arguments) upon which the function is dependent are resolved (valid).

At decision block 650, a determination is made regarding whether any of the input variable arguments of the function are currently invalid. If so, processing loops back to decision block 610 to process the next event; otherwise, processing continues with block 630.

At block 630, the executer is caused to execute the function based on the values of the input variable arguments. For example, the service scheduler may examine the function descriptor and determine the name/ID of the function to invoke. Immediate data may be passed to the executer unmodified. For reference arguments, the service scheduler may pass the values obtained in block 620. Upon conclusion of execution a function descriptor, output data represented as references will be stored via the memory manager in block 640. Following block 630, service scheduling processing may loop back to decision block 610 to process the next event.

At block 640, a memory manager (e.g., memory manager 240) is caused to persist values of output variable arguments of the completed function call. For example, the service scheduler may process each output variable argument and cause the memory manager to set the value of the output variable argument based on the corresponding global memory reference. As described below with reference to FIG. 7, in one embodiment, the persisting of the values of the output variable arguments of the completed function call cause any previously delayed function whose inputs are now satisfied to be scheduled. Following block 620, service scheduling processing may loop back to decision block 610 to process the next event.

### Example Memory Management Processing

FIG. 7 is a flow diagram illustrating operations for performing memory management processing according to some embodiments. In one embodiment, memory management processing is performed by a memory manager (e.g., memory manager 240) after or responsive to an event that is indicative of receipt of a request from an application (e.g., application 211) or a function dispatcher (e.g., function dispatcher 212) to create a new global memory reference, an event that is indicative of receipt of a get request from a service scheduler (e.g., service scheduler 232) for values of input argument global memory references, or an event that is indicative of receipt of a set request from the service scheduler to set a value of a global memory reference. In the context of the present example, the memory manager is responsible for, among other things, delaying execution of functions that have a data dependency, determining when the dependencies of a given delayed function have been resolved, and notifying the service scheduler when the given delayed function is ready for execution.

At decision block 705, a determination is made regarding what the event represents. If the event represents receipt of a create request, processing continues with block 710. If the event represents receipt of a get request, processing branches to decision block 720. If the event represents receipt of a set request, processing continues with block 7335.

At block 710, a new global memory references is generated for the requester. For example, the memory manager allocates argument data storage (e.g., stores 252a) within a memory managed by the memory manager, creates a new token (e.g., references 251a) that identifies the newly allocated argument data storage, initializes the state (e.g., state 253a) of the argument data storage. The memory manager may also create a corresponding list (e.g., pending queue 254a), which is initially empty, for functions that are awaiting a valid value of the corresponding argument data storage.

At block 715, the new global memory reference generated at block 710 is returned to the requester. Following block 715, memory management processing may loop back to decision block 705 to process the next event.

At decision block 720, it is determined whether all stores for values of input argument global memory references requested are valid. If so, processing branches to block 730; otherwise, processing continues with block 725.

At block 725, execution of the function is delayed and an indication of the delayed status is returned to the requester. For example, the memory manager may add the function ID of the function to the list (pending queue) of each global memory reference for which a value was requested that has invalid store. In one embodiment, a reference count may be maintained for each function that is indicative of the number of values for which the function is awaiting to be resolved. For example, the reference count for a given function may be incremented for each list (pending queue) of a global memory reference to which it is added.

At block 730, the requested values of the input argument global memory references are returned to the requester. Following block 730, memory management processing may loop back to decision block 705 to process the next event.

At block 735, the store corresponding to the global memory reference is set to the specified value and the corresponding state is set to valid.

At block 740, the functions on pending queue (delayed functions) of the global memory reference are dequeued and their respective reference counts are updated. For example, the reference count for each delayed function on the pending queue may be decremented.

At decision block 745, a determination is made regarding whether any previously delayed functions are now ready to be executed. If so, processing continues with block 750; otherwise, processing loops back to decision block 750 to process the next event. According to one embodiment, this determination involves evaluating whether any of the reference counts are equal to zero (meaning the function at issue has no further data dependencies).

At block 750, the service scheduler is notified. For example, the memory manager may invoke a method exposed by the service scheduler to trigger the service scheduler to proceed with the execution of a previously delayed function by providing the function ID of the function as well as values of the input argument global memory references of the function.

While in the context of the flow diagrams presented herein, a number of enumerated blocks are included, it is to be understood that the examples may include additional blocks before, after, and/or in between the enumerated blocks. Similarly, in some examples, one or more of the enumerated blocks may be omitted or performed in a different order.

### Example Step-by-Step Processing for a Particular Sequence of Function Calls

FIGS. 8A-G are message sequence diagrams illustrating step-by-step processing of a sequence of function calls according to some embodiments. For purposes of comparison, in the context of the present example, it is assumed the same ordered sequence of function calls (F₁, F₂, F₃, and F₄) as described above with reference to FIG. 1B is originated by an application (e.g., application 811, which may be analogous to application 211) and sent via an interconnect (e.g., interconnect 220) to an executer (e.g., executer 831, which may be analogous to executer 231).

In the example represented by FIGS. 8A-G, the states of global memory references (e.g., reference ID 851), and corresponding stores (e.g., store 852), corresponding states (e.g., state 853), and corresponding pending queues (e.g., pending queue 854) maintained by a memory manager 840 (which may be analogous to memory manager 240) are shown as various requests are made to the memory manager and as the memory manager performs memory management processing (e.g., the processing described above with reference to FIG. 7). In each of FIGS. 8A-G, those of the global memory references, stores, states, and/or pending queues that are changes as a result of the processing described with reference to that figure are shown with a gray background.

In FIG. 8A, an initial state of global memory references (e.g., reference ID 851) and corresponding stores (e.g., store 852), corresponding states (e.g., state 853), and corresponding pending queues (e.g., pending queue 854) maintained by the memory manager 840 is shown after the application 811 (or an intermediary) has requested global memory references for each of the functions to be executed from the memory manager 840 and after the memory manager 840 has registered each of the global memory references.

In one embodiment, before scheduling a function, the application 811 gets storage and global memory references for all of the variable (i.e., non-constant) function arguments from the memory manager 840. As noted above, this can be done explicitly by the application 811 or transparently by a framework provided on an application platform (e.g., application platform 210) on which the application 811 is running, for example, via a function dispatcher (e.g., function dispatcher 212). For each variable argument, the memory manager allocates a logical global storage for the value and keeps a record of the global memory reference, the status of its storage (initially invalid) and a list of any functions waiting on this value (initially empty).

As can be seen in FIG. 8A, Oᵣ₁ represents the reference ID for the global memory reference of variable argument O₁, which represents an output variable argument of F₁ and an input variable argument to both F₂ and F₄. Oᵣ₂ represents the reference ID for the global memory reference of variable argument O₂, which represents an output variable argument of F₂ an input variable argument to F₄. Oᵣ₃ represents the reference ID for the global memory reference of variable argument O₃, which represents an output variable argument of F₄. The stores of all global memory references are initially invalid and the pending queues of all global memory references are initial empty.

Additionally, in FIG. 8A, a first function call (e.g., F₁) of the ordered sequence of function calls is transmitted from an application platform (e.g., application platform 210) to a service scheduler 832 (which may be analogous to service scheduler 232) running on a server platform (e.g., server platform 230) on which the executer 821 resides. As noted above, a given function arguments may be tagged as an input reference, an output reference, or an immediate (i.e., a constant) by the calling application 811 or transparently by the underlying function dispatcher 212 if it can discern the argument types. The function request is then transmitted to the executer (via the service scheduler 832) across the interconnect 220, for example, using serialization/deserialization techniques.

When receiving a function request the service scheduler 832 may employ the memory manager 840 to examine the states of all input argument global memory references of the function request. If any do not have a valid value in the store, the function is placed on the pending queue for that global memory reference. This is repeated for every unresolved input argument global memory reference.

Responsive to receipt of the function call (F₁), the service scheduler 832 makes use of the memory manager to determine whether F₁ has any data dependencies (e.g., whether it has any input argument global memory references whose corresponding stores are invalid). As F₁, has no data dependencies, it may be immediately scheduled for execution by the executer 831. Since the application need not wait for F to complete, it then requests the next function in the transaction, F₂, be executed.

In FIG. 8B, the next function call (F₂) of the ordered sequence of function calls has now been transmitted to the service scheduler 832. As above, the service scheduler 832 makes use of the memory manager 840 to determine whether F₂ has any input dependencies. That is, whether any of the input argument global memory references of F₂ have invalid values in their respective stores. In this case, F₂ is dependent upon the value of Oᵣ₁, which is currently invalid as the execution of F₁ has not yet completed. As such, execution of F₂ is delayed until all of its dependencies are satisfied. In this example, the memory manager 840 records the fact that F₂ is waiting for the value of Oᵣ₁ by adding the ID of F₂ to the pending queue of Oᵣ₁. Additionally, the reference count for F₂ is updated (e.g., incremented to 1). The application 811 next invokes F₃ and F₄ as soon as possible. The function F₃ has no dependencies and can execute immediately, concurrent to F₁ and potentially F₂.

In FIG. 8C, the next function call (F₃) of the ordered sequence of function calls has now been transmitted to the service scheduler 832. As above, the service scheduler 832 makes use of the memory manager 840 to determine whether F₃ has any input dependencies. As F₃ has no dependencies, it can be immediately scheduled to execute by executer 831. In this example, execution of F₃ overlaps with the continued execution of F₁.

In FIG. 8D, the next function call (F₄) of the ordered sequence of function calls has now been transmitted to the service scheduler 832. As above, the service scheduler 832 makes use of the memory manager 840 to determine whether F₄ has any input dependencies. In this case, F₄ is dependent upon the value of Oᵣ₁ and Oᵣ₂, which are both currently invalid (awaiting completion of execution of F₁ and F₂, respectively). As such, the ID of F₄ is added to the pending queue of Oᵣ₁ and the pending queue of Oᵣ₂ and the reference count for F₄ is updated (e.g., incremented to 2). Meanwhile, in this example, it is assumed F₁ and F₃ continue to be executed by the executer 831.

In FIG. 8E, execution of F₁ completes, causing the value (O1) within the store of Oᵣ₁ to be updated and the corresponding state to be updated to valid. Additionally, the pending queue of Oᵣ₁ is dequeued to remove F₂ and F₄ from the pending queue and the reference count of each function removed from the pending queue is updated. In this case, the reference count for F₂ is decremented to 0 (as it is no longer waiting for any other value) and the reference count for F₄ is decremented to 1 (as it is still waiting for the value of Oᵣ₂). At this point, when the memory manager evaluates whether any previously delayed function is now ready to be executed (e.g., whether any function's reference count is zero), it determines F₂ is ready to be executed and triggers execution of F₂ by notifying the service scheduler that F₂ is ready to be executed. As a result, F₂ is now executing concurrently with F₃.

In FIG. 8F, execution of F₂ completes, causing the value (O2) within the store of Oᵣ₂ to be updated and the corresponding state to be updated to valid. Additionally, the pending queue of Oᵣ₂ is dequeued to remove F₄ from the pending queue and the reference count of F₄ is updated. In this case, the reference count for F₄ is decremented to 0 (as it is no longer waiting for any other value). At this point, when the memory manager evaluates whether any previously delayed function is now ready to be executed (e.g., whether any function's reference count is zero), it determines F₄ is finally ready to be executed and triggers execution of F₄ by notifying the service scheduler that F₄ is ready to be executed. As a result, F₄ is now executing concurrently with F₃.

In FIG. 8G, execution of F₃ completes and execution of F₄ completes, causing the value (O3) within the store of Oᵣ₃ to be updated and the corresponding state to be updated to valid. At this point, no further functions are awaiting execution and the global memory reference for O3 is returned to the application, making the final result O3 available to be read by the application.

Based on the above example, the realized execution sequence is not [F₁, F₂, F₃, F₄] as indicated by the application but rather is [F₁, F₃, F₂, F₄]. As will be appreciated, total latency has been reduced by allowing functions to be overlapped. It is to be further appreciated that only the final O3 argument need be sent back across the interconnect as O1 and O2 are only used by the Executer. As such, as compared to the example of FIG. 1B, in the present example, all waiting is effectively done in the target (the server platform).

While in the context of various examples, function arguments represent the data dependencies, it is to be understood that the methodologies described herein may also be used in cases in which the function dependency is not obvious by examining the arguments. For example, in a scenario in which two functions must be executed in a particular sequence even though no argument dependency exists, the return status of a function may be used as a dependency. Consider the following example:
Status=initSystem( );
F₁( . . . )

In this example, the function initSystem( ) must be called prior to F₁ (or any other call for that matter). In such a case, the dependent argument is the return value of initSystem( ). As such, a return status indicating that a function has executed successfully may be used in the same was as any other variable argument for purposes of determining the existence of data dependencies. In this example, all other functions may state that they are dependent on the value of Status.

Taking this notion one step further, in the example above a Boolean flag is used to indicate the presence or absence of a particular dependent data value. In one embodiment, a service scheduler (e.g., service scheduler 232) may consider the actual value of the variable in the rules when determining the fitness of a function to run. As an example, the rule for the above initSystem( ) might be that not only must Status be valid, but it must have a particular value (e.g., Okay) for functions to proceed. An alternative rule could be set for another value (e.g., NotOkay) which could trigger a failure function to execute.

### Example Computer System

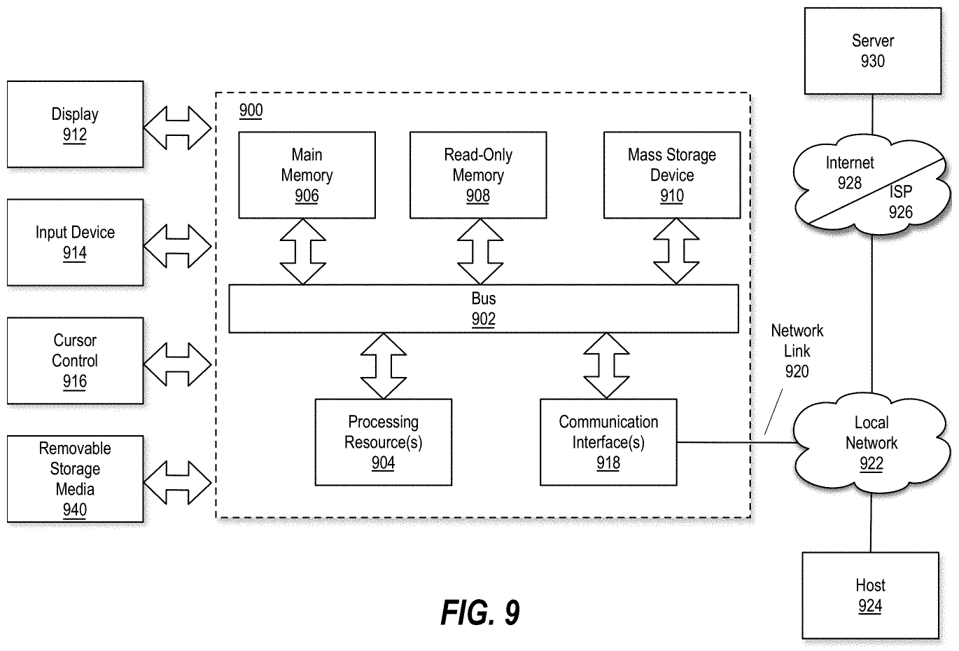

FIG. 9 is an example of a computer system 900 with which some embodiments may be utilized. Notably, components of computer system 900 described herein are meant only to exemplify various possibilities. In no way should example computer system 900 limit the scope of the present disclosure. In the context of the present example, computer system 900 includes a bus 902 or other communication mechanism for communicating information, and one or more processing resources 904 coupled with bus 902 for processing information. The processing resources may be, for example, a combination of one or more compute resources (e.g., a microcontroller, a microprocessor, a CPU, a CPU core, a GPU, a GPU core, an ASIC, an FPGA, or the like) or a system on a chip (SoC) integrated circuit. Referring back to FIG. 2, depending upon the particular implementation, the application platform 210 may be analogous to computer system 900 and the server platform 230 may be analogous to host 924 or server 930 or the application platform 210 may be analogous to a first compute resource of computer system 900 and the server platform 230 may be analogous to a second compute resource of computer system 900.

Computer system 900 also includes a main memory 906, such as a random-access memory (RAM) or other dynamic storage device, coupled to bus 902 for storing information and instructions to be executed by processor 904. Main memory 906 also may be used for storing temporary variables or other intermediate information during execution of instructions to be executed by processor 904. Such instructions, when stored in non-transitory storage media accessible to processor 904, render computer system 900 into a special-purpose machine that is customized to perform the operations specified in the instructions.

Computer system 900 further includes a read only memory (ROM) 908 or other static storage device coupled to bus 902 for storing static information and instructions for processor 904. A storage device 910, e.g., a magnetic disk, optical disk or flash disk (made of flash memory chips), is provided and coupled to bus 902 for storing information and instructions.

Computer system 900 may be coupled via bus 902 to a display 912, e.g., a cathode ray tube (CRT), Liquid Crystal Display (LCD), Organic Light-Emitting Diode Display (OLED), Digital Light Processing Display (DLP) or the like, for displaying information to a computer user. An input device 914, including alphanumeric and other keys, is coupled to bus 902 for communicating information and command selections to processor 904. Another type of user input device is cursor control 916, such as a mouse, a trackball, a trackpad, or cursor direction keys for communicating direction information and command selections to processor 904 and for controlling cursor movement on display 912. This input device typically has two degrees of freedom in two axes, a first axis (e.g., x) and a second axis (e.g., y), that allows the device to specify positions in a plane.

Removable storage media 940 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 900 may implement the techniques described herein using customized hard-wired logic, one or more ASICs or FPGAs, firmware or program logic which in combination with the computer system causes or programs computer system 900 to be a special-purpose machine. According to one embodiment, the techniques herein are performed by computer system 900 in response to processor 904 executing one or more sequences of one or more instructions contained in main memory 906. Such instructions may be read into main memory 906 from another storage medium, such as storage device 910. Execution of the sequences of instructions contained in main memory 906 causes processor 904 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 910. Volatile media includes dynamic memory, such as main memory 906. Common forms of storage media include, for example, a flexible disk, a hard disk, a solid-state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 902. Transmission media can also take the form of acoustic or light waves, such as those generated during radio-wave and infra-red data communications.

Various forms of media may be involved in carrying one or more sequences of one or more instructions to processor 904 for execution. For example, the instructions may initially be carried on a magnetic disk or solid-state drive of a remote computer. The remote computer can load the instructions into its dynamic memory and send the instructions over a telephone line using a modem. A modem local to computer system 900 can receive the data on the telephone line and use an infra-red transmitter to convert the data to an infra-red signal. An infra-red detector can receive the data carried in the infra-red signal and appropriate circuitry can place the data on bus 902. Bus 902 carries the data to main memory 906, from which processor 904 retrieves and executes the instructions. The instructions received by main memory 906 may optionally be stored on storage device 910 either before or after execution by processor 904.

Computer system 900 also includes interface circuitry 918 coupled to bus 902. The interface circuitry 918 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. As such, interface 918 may couple the processing resource in communication with one or more discrete accelerators 905 (e.g., one or more XPUs).

Interface 918 may also provide a two-way data communication coupling to a network link 920 that is connected to a local network 922. For example, interface 918 may be an integrated services digital network (ISDN) card, cable modem, satellite modem, or a modem to provide a data communication connection to a corresponding type of telephone line. As another example, interface 918 may be a local area network (LAN) card to provide a data communication connection to a compatible LAN. Wireless links may also be implemented. In any such implementation, interface 918 may send and receive electrical, electromagnetic or optical signals that carry digital data streams representing various types of information.

Network link 920 typically provides data communication through one or more networks to other data devices. For example, network link 920 may provide a connection through local network 922 to a host computer 924 or to data equipment operated by an Internet Service Provider (ISP) 926. ISP 926 in turn provides data communication services through the worldwide packet data communication network now commonly referred to as the “Internet” 928. Local network 922 and Internet 928 both use electrical, electromagnetic or optical signals that carry digital data streams. The signals through the various networks and the signals on network link 920 and through communication interface 918, which carry the digital data to and from computer system 900, are example forms of transmission media.

Computer system 900 can send messages and receive data, including program code, through the network(s), network link 920 and communication interface 918. In the Internet example, a server 930 might transmit a requested code for an application program through Internet 928, ISP 926, local network 922 and communication interface 918. The received code may be executed by processor 904 as it is received, or stored in storage device 910, or other non-volatile storage for later execution.

While many of the methods may be described herein in a basic form, it is to be noted that processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments requires more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system for facilitating hybrid communication according to embodiments and examples described herein.

Some embodiments pertain to Example 1 that includes a non-transitory machine-readable medium storing instructions, which when executed by a processing resource of a computer system cause the processing resource to: determine whether a first function associated with a transactional application programming interface (API) that is to be carried out by an executer on behalf of an application has a data dependency on a value that is invalid; after an affirmative determination that the value is invalid, cause a function identifier (ID) of the first function to be queued, for example, on a pending queue for a global memory reference associated with the value; and after the value becomes valid, cause the first function to be executed by the executer.

Example 2 includes the subject matter of Example 1, wherein the instructions further cause the processing resource to after a negative determination that the value is invalid, cause the first function to be executed by the executer.

Example 3 includes the subject matter of any of Examples 1-2, wherein the value is associated with an input argument of the first function and wherein the value is set after completion of execution of a second function of the transactional API as a result of the value being associated with an output argument of the second function.

Example 4 includes the subject matter of any of Examples 1-3, wherein the instructions further cause the processing resource to cause execution of a third function of the transactional API to be started by the executer prior to execution of the first function, wherein the third function has no data dependencies and was received after the first function.

Example 5 includes the subject matter of Example 4, wherein execution of the first function by the executer overlaps execution of the third function.

Example 6 includes the subject matter of any of Examples 1-5, wherein the instructions further cause the processing resource to maintain a reference count for the first function that is indicative of a number of a plurality of values of output arguments of one or more other functions of the transactional API upon which the first function is dependent.

Example 7 includes the subject matter of Example 6, wherein the instructions further cause the processing resource to update the reference count when the function ID is queued for a global memory reference associated with a respective value of the plurality of values.

Example 8 includes the subject matter of Example 6, wherein the instructions further cause the processing resource to update the reference count after a given value of the plurality of values becomes valid.

Some embodiments pertain to Example 9 that includes a method comprising: determining whether a first function associated with a transactional application programming interface (API) that is to be carried out by an executer on behalf of an application has a data dependency on a value that is invalid; after an affirmative determination that the value is invalid, causing a function identifier (ID) of the first function to be queued, for example, on a pending queue for a global memory reference associated with the value; and after the value becomes valid, causing the first function to be executed by the executer.

Example 10 includes the subject matter of Example 9, further comprising after a negative determination that the value is invalid, causing the first function to be executed by the executer.

Example 11 includes the subject matter of any of Examples 9-10, wherein the value is associated with an input argument of the first function and wherein the value is set after completion of execution of a second function of the transactional API as a result of the value being associated with an output argument of the second function.

Example 12 includes the subject matter of any of Examples 9-11, further comprising causing execution of a third function of the transactional API to be started by the executer prior to execution of the first function, wherein the third function has no data dependencies and was received after the first function.

Example 13 includes the subject matter of Example 12, wherein execution of the first function by the executer overlaps execution of the third function.

Example 14 includes the subject matter of any of Examples 9-13, further comprising maintaining a reference count for the first function that is indicative of a number of a plurality of values of output arguments of one or more other functions of the transactional API upon which the first function is dependent.

Example 15 includes the subject matter of Example 14, further comprising updating the reference count when the function ID is queued on a pending queue of a global memory reference associated with a respective value of the plurality of values.

Example 16 includes the subject matter of Example 14, further comprising updating the reference count after a given value of the plurality of values becomes valid.

Example 17 includes the subject matter of any of Examples 13-16, wherein the first function call, the second function call, and the third function call comprise remote procedure calls (RPCs).

Some embodiments pertain to Example 18 that includes a computer system comprising: a first processing resource; and instructions, which when executed by the first processing resource cause the first processing resource to: determine whether a first function to be carried out on behalf of an application associated with a second processing resource remote from the first processing resource has a data dependency on a value that is invalid, wherein the first function is associated with a transactional application programming interface (API); after an affirmative determination: cause a function identifier (ID) of the first function to be queued on a pending queue for a global memory reference associated with the value; and after the value is valid: receive an indication that the first function is ready to be executed; and cause the first function to be executed by the executer.

Example 19 includes the subject matter of Example 18, wherein the value is associated with an input argument of the first function and wherein the value is set after completion of execution of a second function of the transactional API as a result of the value being associated with an output argument of the second function.

Example 20 includes the subject matter of any of Examples 18-19, wherein the instructions further cause the first processing resource to maintain a reference count for the first function that is indicative of a number of a plurality of values of output arguments of one or more other functions of the transactional API upon which the first function is dependent.

Example 21 includes the subject matter of Example 20, wherein the instructions further cause the first processing resource to update the reference count when the function ID is queued on a pending queue of a global memory reference associated with a respective value of the plurality of values.

Example 22 includes the subject matter of Example 20, wherein the instructions further cause the first processing resource to update the reference count after a given value of the plurality of values becomes valid.

Example 23 includes the subject matter of any of Examples 18-22, wherein the first processing resource comprises a central processing unit (CPU), a graphics processing unit (GPU), an application-specific integrated circuit (ASIC), or a field-programmable gate array (FPGA).

Example 24 includes the subject matter of any of Examples 18-23, wherein the second processing resource comprises a CPU, a GPU, an ASIC, or an FPGA of a second computer system.

Example 25 includes the subject matter of any of Examples 18-23, wherein the second processing resource comprises a second CPU, a second GPU, a second ASIC, or a second FPGA of the computer system.

Some embodiments pertain to Example 25 that includes an apparatus that implements or performs a method of any of Examples 9-17.

Example 26 includes at least one machine-readable medium comprising a plurality of instructions, when executed on a computing device, implement or perform a method or realize an apparatus as described in any preceding Example.

Example 27 includes an apparatus comprising means for performing a method as claimed in any of Examples 9-17.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A non-transitory machine-readable medium storing instructions, which when executed by a processing resource of a computer system cause the processing resource to:
determine whether a first function associated with a transactional application programming interface (API) that is to be carried out by an executer on behalf of an application has a data dependency on a value that is invalid;
after an affirmative determination that the value is invalid, cause a function identifier (ID) of the first function to be queued for a global memory reference associated with the value; and
after the value becomes valid, cause the first function to be executed by the executer.

2. The non-transitory machine-readable medium of claim 1, wherein the instructions further cause the processing resource to after a negative determination that the value is invalid, cause the first function to be executed by the executer.

3. The non-transitory machine-readable medium of claim 1, wherein the value is associated with an input argument of the first function and wherein the value is set after completion of execution of a second function of the transactional API as a result of the value being associated with an output argument of the second function.

4. The non-transitory machine-readable medium of claim 3, wherein the instructions further cause the processing resource to cause execution of a third function of the transactional API to be started by the executer prior to execution of the first function, wherein the third function has no data dependencies and was received after the first function.

5. The non-transitory machine-readable medium of claim 4, wherein execution of the first function by the executer overlaps execution of the third function.

6. The non-transitory machine-readable medium of claim 1, wherein the instructions further cause the processing resource to maintain a reference count for the first function that is indicative of a number of a plurality of values of output arguments of one or more other functions of the transactional API upon which the first function is dependent.

7. The non-transitory machine-readable medium of claim 6, wherein the instructions further cause the processing resource to update the reference count when the function ID is queued for a global memory reference associated with a respective value of the plurality of values.

8. The non-transitory machine-readable medium of claim 6, wherein the instructions further cause the processing resource to update the reference count after a given value of the plurality of values becomes valid.

9. A method comprising:
determining whether a first function associated with a transactional application programming interface (API) that is to be carried out by an executer on behalf of an application has a data dependency on a value that is invalid;
after an affirmative determination that the value is invalid, causing a function identifier (ID) of the first function to be queued for a global memory reference associated with the value; and
after the value becomes valid, causing the first function to be executed by the executer.

10. The method of claim 9, further comprising after a negative determination that the value is invalid, causing the first function to be executed by the executer.

11. The method of claim 9, wherein the value is associated with an input argument of the first function and wherein the value is set after completion of execution of a second function of the transactional API as a result of the value being associated with an output argument of the second function.

12. The method of claim 11, further comprising causing execution of a third function of the transactional API to be started by the executer prior to execution of the first function, wherein the third function has no data dependencies and was received after the first function.

13. The method of claim 12, wherein execution of the first function by the executer overlaps execution of the third function.

14. The method of claim 9, further comprising maintaining a reference count for the first function that is indicative of a number of a plurality of values of output arguments of one or more other functions of the transactional API upon which the first function is dependent.

15. The method of claim 14, further comprising updating the reference count when the function ID is queued for a global memory reference associated with a respective value of the plurality of values.

16. The method of claim 14, further comprising updating the reference count after a given value of the plurality of values becomes valid.

17. The method of claim 13, wherein the first function call, the second function call, and the third function call comprise remote procedure calls (RPCs).

18. A computer system comprising:
a first processing resource; and
instructions, which when executed by the first processing resource cause the first processing resource to:
determine whether a first function to be carried out on behalf of an application associated with a second processing resource remote from the first processing resource has a data dependency on a value that is invalid, wherein the first function is associated with a transactional application programming interface (API);
after an affirmative determination:
cause a function identifier (ID) of the first function to be queued on a pending queue for a global memory reference associated with the value; and
after the value is valid:
receive an indication that the first function is ready to be executed; and
cause the first function to be executed by the executer.

19. The computer system of claim 18, wherein the value is associated with an input argument of the first function and wherein the value is set after completion of execution of a second function of the transactional API as a result of the value being associated with an output argument of the second function.

20. The computer system of claim 18, wherein the instructions further cause the first processing resource to maintain a reference count for the first function that is indicative of a number of a plurality of values of output arguments of one or more other functions of the transactional API upon which the first function is dependent.

21. The computer system of claim 20, wherein the instructions further cause the first processing resource to update the reference count when the function ID is queued on a pending queue of a global memory reference associated with a respective value of the plurality of values.

22. The computer system of claim 20, wherein the instructions further cause the first processing resource to update the reference count after a given value of the plurality of values becomes valid.

23. The computer system of claim 18, wherein the first processing resource comprises a central processing unit (CPU), a graphics processing unit (GPU), an application-specific integrated circuit (ASIC), or a field-programmable gate array (FPGA).

24. The computer system of claim 23, wherein the second processing resource comprises a CPU, a GPU, an ASIC, or an FPGA of a second computer system.

25. The computer system of claim 23, wherein the second processing resource comprises a second CPU, a second GPU, a second ASIC, or a second FPGA of the computer system.
